(19) United States
(12) Patent Application Publication
(10) Pub. No.: US 2026/0344719 A1
(43) Pub. Date: Nov. 5, 2026

(54) COMPOSITIONS WITH SUGAR-LIKE CHARACTERISTICS

(71) Applicants: PURECIRCLE SDN. BHD., NEGERI SEMBILAN (MY); CORN PRODUCTS DEVELOPMENT, INC., WESTCHESTER, IL (US)

(72) Inventors: Avetik MARKOSYAN, Negeri Semilan (MY); Kasi SUNDARESAN, Bridgewater, NJ (US); Saravanan A/L RAMANDACH, Negeri Sembilan (MY); Mohamad Afzaal BIN HASIM, Negeri Sembilan (MY); Maryam SAYEED, Bridgewater, NJ (US); Khairul NIZAM BIN NAWI, Negeri Sembilan (MY); Siddhartha PURKAYASTHA, Bridgewater, NJ (US); Adams BERZINS, Bridgewater, NJ (US)

(21) Appl. No.: 19/099,314

(22) PCT Filed: Jul. 27, 2023
(86) PCT No.: PCT/MY2023/050056

§ 371 Date: Jan. 28, 2025

(30) Foreign Application Priority Data
Jul. 29, 2022 (MY) PI2022004064

(51) Int. Cl. A23L 27/30; A23L 2/385; A23L 2/60

(52) U.S. Cl. CPC A23L 27/36; A23L 2/385; A23L 2/60

(57) ABSTRACT

Disclosed herein are consumable food, beverage and other products comprising an effective amount of a steviol glycoside sweetener composition to provide a sucrose sweetness equivalence of at least 1%, said composition comprising 5-30 wt % rebaudioside M (reb M), 15-35 wt % rebaudioside AM (reb AM), and 10-25 wt % rebaudioside N2 (reb N2) based on the total amount of steviol glycosides in the consumable product. Beneficially, the sweetener compositions provide characteristics like that of sucrose that include maximal response, flavor profile, temporal profile, adaptation behavior and mouthfeel. The sweetener compositions can be included in various food, beverage, and other consumable products to provide a clean sugar-like taste and may be used as sweeteners or sweetness enhancers in reduced sugar food, beverage, and other consumable products.

### TECHNICAL FIELD

Disclosed herein are food, beverage, and other consumable products comprising steviol glycoside sweetener compositions. Beneficially, the sweetener compositions provide characteristics like that of sucrose that include maximal response, flavor profile, temporal profile, adaptation behavior and mouthfeel. The sweetener compositions can be included in various food, beverage, and other consumable products to provide a clean sugar-like taste and may be used as sweeteners or sweetness enhancers in reduced sugar food, beverage, and other consumable products.

### BACKGROUND

Sugars and sweeteners are widely used in food, beverage, and other consumable products and play a critical role in consumer's selection and enjoyment of such products. Sugars are desirable for their sweet taste and/or the flavor they elicit. Sucrose imparts a taste preferred by consumers that is the ‘gold standard’ in terms of the desired onset (appearance time) and decay of sweetness (extinction time). Although sucrose provides superior sweetness characteristics, it is caloric. Non-caloric or low caloric sweeteners, both nutritive and non-nutritive, have been introduced to satisfy consumer demand for sweet tasting products that provide with non-caloric or low-caloric sweetness.

A key challenge in replacing sucrose with non-nutritive high potency sweeteners is to achieve a sweetness profile like sucrose. In addition, sweeteners can be challenging to formulate into products such as foods and beverages. Sweeteners cannot simply be substituted into products that contain sugars. Various formulation and processing challenges can exist, including finding the desirable sugar taste when using combined sugars and/or sweeteners, along with removing any undesirable taste properties that they can impart. On a taste basis, non-caloric or low caloric sweeteners exhibit a temporal profile, maximal response, flavor profile, mouthfeel, and/or adaptation behavior that differ from sugar. Specifically, non-caloric or low caloric sweeteners exhibit delayed sweetness onset, lingering sweet aftertaste, bitter taste, metallic taste, astringent taste, cooling taste and/or licorice-like taste.

Accordingly, there is an ongoing demand for sweetener compositions that provide ‘sugar like’ characteristics, including the maximal response, flavor profile (i.e., lack of detectable off tastes (e.g., metallic, licorice and bitter notes)), cooling and adaptation behaviors of sucrose. There is also a mouthfeel aspect that's characteristic of “sugar like” taste. There is a clear consumer desire for natural non-caloric and/or low caloric sweeteners that have the same taste quality as sucrose.

There is also a further need to develop natural reduced or non-caloric sweeteners (also referred to as low calorie and/or zero calorie sweeteners) that provide temporal and flavor profile similar to that of sucrose. This need is to replace detectable off tastes (e.g., metallic, licorice and bitter notes), cooling, and adaptation behaviors of high potency sweeteners while still providing a natural non-caloric sweetener that has the same taste quality as sucrose.

In addition, there remains a further need to develop sweetened compositions, such as foods, beverage, and/or other consumable products containing reduced or non-caloric sweetener compositions having more sugar-like characteristics than currently available reduced or non-caloric sweetener compositions.

### SUMMARY

Disclosed herein are consumable food, beverage or other products comprising an effective amount of a steviol glycoside sweetener composition to provide a sucrose sweetness equivalence of at least 1%, said composition comprising 5-30 wt % rebaudioside M (reb M), 15-35 wt % rebaudioside AM (reb AM), and 10-25 wt % rebaudioside N2 (reb N2) based on the total amount of steviol glycosides in the consumable product.

Also disclosed are consumable food, beverage or other products comprising from about 5 ppm to about 5000 ppm of a steviol glycoside sweetener composition comprising 5-30 wt % rebaudioside M (reb M), 15-35 wt % rebaudioside AM (reb AM), and 10-25 wt % rebaudioside N2 (reb N2) based on the total amount of steviol glycosides in the consumable product, wherein the consumable product has an equivalent sweetness to sucrose solutions having concentrations between 5 ppm-10,000 ppm (1-40SSE).

Also disclosed are methods for enhancing the sugar-like characteristics of a consumable food, beverage or other product comprising the step of: adding to a consumable product composition that is sweetenable a steviol glycoside sweetener composition comprising 5-30 wt % rebaudioside M (reb M), 15-35 wt % rebaudioside AM (reb AM), and 10-25 wt % rebaudioside N2 (reb N2) based on the total amount of steviol glycosides in the consumable product.

Also disclosed are methods for imparting a sugar-like temporal profile, sugar-like flavor profile, or both, to a consumable food, beverage or other product comprising adding from about 5 ppm to about 5000 ppm of a steviol glycoside sweetener composition to the product, said composition comprising 5-30 wt % rebaudioside M (reb M), 15-35 wt % rebaudioside AM (reb AM), and 10-25 wt % rebaudioside N2 (reb N2) based on the total amount of steviol glycosides in the consumable product.

### BRIEF DESCRIPTION OF THE DRAWINGS

FIG. 1a is a sweet taste evaluation comparing Composition A (straight line) and reb M 90% (dotted line) in buffer; and

FIG. 1b is a bitter taste evaluation comparing Composition A (straight line) and reb M 90% (dotted line) in buffer.

### DETAILED DESCRIPTION

In the following description, numerous specific details are set forth in order to provide a thorough understanding of the present invention. However, unless otherwise indicated or implicit from context, the details are intended to be examples and should not be deemed to limit the scope of the invention in any way. Additionally, features described in connection with the various or specific embodiments are not to be construed as not appropriate for use in connection with other embodiments disclosed herein unless such exclusivity is explicitly stated or implicit from context.

All terminology used herein is for the purpose of describing particular embodiments only and is not intended to be limiting in any manner or scope. For example, as used in this specification and the appended claims, the singular forms “a,” “an” and “the” can include plurals unless the context clearly indicates otherwise. Further, all units, prefixes, and symbols may be denoted in its SI accepted form. Numeric ranges recited within the specification are inclusive of the numbers within the defined range. Throughout this disclosure, various aspects are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2.75, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments without undue experimentation. In describing and claiming the embodiments, the following terminology will be used in accordance with the definitions set out below.

The term “about”, as used herein, refers to variations in the numerical quantity that can occur, for example, through typical measuring and handling procedures; through inadvertent error in these procedures; through differences in the manufacture, source, or purity of the ingredients; and the like. Whether or not modified by the term “about”, the claims include equivalents to the quantities.

As used herein, the term “Brix” refers to the sugar content of an aqueous solution in terms of sucrose. One degree Brix is 1 gram of sucrose in 100 grams of solution. The Brix of a sweetener compound or composition may be calculated from the degree of sweetness relative to sucrose using a sensory panel. Sweetness equivalent in Brix of sweetener compounds can be calculated similarly from the concentration response as determined using a sensory panel. Approximate relative sweetness values for sweeteners that may be used as alternatives to sucrose are listed in Table 1.1 of “Alternative Sweeteners” 4th Edition, Lyn O'Brien-Nabors CRC Press, published Oct. 26, 2016, ISBN 9781138198562-CAT #K31388. The contents of this reference are incorporated herein by reference in its entirety for all purposes.

As used herein, the term “ppm”, as used herein, means parts-per-million and is a weight relative parameter. A part-per-million is a microgram per gram, such that a component that is present at 10 ppm is present at 10 micrograms of the specific component per 1 gram of the aggregate mixture.

As used herein, the phrases “sugar-like characteristic,” “sugar-like taste,” “sugar-like sweet,” “sugary,” and “sugar-like” are synonymous. Sugar-like characteristics include any characteristic similar to that of sucrose and include, but are not limited to, maximal response, flavor profile, temporal profile, adaptation behavior, mouthfeel, concentration/response function behavior, tastant and flavor/sweet taste interactions, and temperature effects. These characteristics are dimensions in which the taste of sucrose is different from the taste of natural and synthetic high-potency sweeteners. Whether or not a characteristic is more sugar-like is determined by expert taster or trained sensory panel assessments of sugar and compositions with and without a steviol glycoside sweetener composition. Such assessments quantify similarities of the characteristics of compositions comprising the sweetener compositions according to the invention compared to those comprising sugar. Suitable procedures for determining whether a composition has a more sugar-like taste are well known in the art. Moreover, the flavor profile of a sweetener composition is a quantitative profile of the relative intensities of all of the taste attributes exhibited. Such profiles often are plotted as histograms or radar plots.

As used herein, “throw syrup” or “concentrated syrup” refers to a composition comprising a sweetener composition dissolved in a volume of liquid medium that is less than the volume of liquid medium contained in a finished beverage product. In one embodiment described herein, the throw syrup or concentrated syrup comprises a ratio of from 1:1 to 120:1 sweetener composition to liquid medium. The throw syrup is combined with a liquid medium to constitute the finished beverage product. The throw syrup may optionally comprise flavoring agents, coloring agents, and other additives such as food-grade acids and preservatives. The reduced volume of liquid medium in the throw syrup allows for reduced storage and shipping costs and increased shelf life. In some embodiments, the throw syrup is formulated to provide a final beverage compositions upon dilution with about a 2-fold to about a 120-fold by volume, for example, 3-fold, 4-fold, 5-fold, 6-fold, 7-fold, 8-fold, 9-fold, 10-fold, etc. to 120-fold by volume, of a liquid medium. For example, a carbonated beverage is produced by first making concentrated syrup and then diluting the syrup with water at the time and place of making the beverage. The dilution ratio for such beverages is often 1:5, meaning one part syrup is mixed with five parts water. The beverage often is carbonated at the time of being bottled or otherwise packaged.

The term “weight percent,” “wt-%,” “percent by weight,” “% by weight,” and variations thereof, as used herein, refer to the concentration of a substance as the weight of that substance divided by the total weight of a composition and multiplied by 100. It is understood that, as used here, “percent,” “%,” and the like are intended to be synonymous with “weight percent,” “wt-%,” etc.

The methods and compositions may comprise, consist essentially of, or consist of the components and ingredients as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Steviol Glycoside Sweetener Compositions

In an embodiment, steviol glycoside sweetener compositions include 5-30 wt % Rebaudioside M (Reb M), 15-35 wt % rebaudioside AM (reb AM), and 10-25 wt % rebaudioside N2 (reb N2) based on the total amount of steviol glycosides in the composition. The sweetener compositions impart a more sugar-like characteristic than compositions without the sweetener composition. In an embodiment, reb M is present in an amount ranging from 10-25 wt % based on the total amount of steviol glycosides in the composition. In an embodiment, reb M is present in an amount ranging from 8-27 wt % based on the total amount of steviol glycosides in the composition. In an embodiment, reb AM is present in an amount ranging from 25-35 wt % based on the total amount of steviol glycosides in the composition. In an embodiment, reb N2 is present in an amount ranging from 10-20 wt % based on the total amount of steviol glycosides in the composition.

As used herein, the abbreviation term “reb” refers to “rebaudioside”. Both terms have the same meaning and may be used interchangeably.

As used herein, the term “steviol glycoside(s)” refers to a glycoside of steviol. Steviol glycosides are diterpene glycosides which are characterized by a single core structure, steviol, and differ by the presence of carbohydrate residues at positions C13 and C19. Steviol glycosides can be natural or produced via fermentation, bioenzymatic cascade, or extraction from the leaves of the Stevia Rebaudiana plant. Example classes of steviol glycosides are steviolmonoside, steviolbioside, rubososide, steviosides, dulcosides, rebaudiosides. Examples of steviol glycosides are steviolmonoside, steviolmonoside A, steviolbioside, steviolbioside D, rubusoside, steviolbioside A, steviolbioside B, rebaudioside B, stevioside, rebaudioside G, stevioside A, stevioside B, stevioside C, rebaudioside C, rebaudioside A, rebaudioside E, rebaudioside E2, rebaudioside E4, rebaudioside E6, rebaudioside E3, rebaudioside D, rebaudioside I, rebaudioside AM, rebaudioside D7, rebaudioside M, rebaudioside M4, rebaudioside N2, rebaudioside O2, rebaudioside 1a, rebaudioside 1b, rebaudioside 1c, rebaudioside 1d, rebaudioside 1e, rebaudioside 1f, rebaudioside 1g, rebaudioside 1h, rebaudioside 1i, rebaudioside 1j, rebaudioside 1k, rebaudioside 1l, rebaudioside 1m, rebaudioside 1n, rebaudioside 2a, synthetic steviol glycosides, e.g. enzymatically glucosylated steviol glycosides and combinations thereof.

In an embodiment, the steviol glycoside composition further comprises rebaudioside O4 (reb O4). In an embodiment, the steviol glycoside composition further comprises from about 3 wt % to about 10 wt % reb 04 based on the total amount of steviol glycosides in the food or beverage product. In an embodiment, the steviol glycoside composition further comprises from about 5 wt % to about 9 wt % reb 04 based on the total amount of steviol glycosides in the food or beverage product.

In an embodiment, the steviol glycoside composition further comprises one or more additional steviol glycosides selected from the group consisting of Reb 2M, Reb M5, Reb D9, Reb 2A, Reb O4, Reb M4, Reb E, Reb O, Reb D, Reb K, Reb N, Reb C2, Reb J, Reb K2, Reb V2, Reb H, Reb I, Reb A, stevioside, Reb F, Reb C, Dulcoside A, Rubusoside, Reb B, Sbio, and combinations thereof.

The remainder of the steviol glycoside composition may be any one or more steviol glycosides.

### Additional Sweeteners

The sweetener compositions may include at least one additional sweetener. Suitable sweeteners for combining with the sweetener composition include for example, fully caloric, low calorie, and/or zero calorie sweeteners. These sweeteners can also be referred to, respectively, as nutritive sweeteners, partially-nutritive sweeteners, and non-nutritive sweeteners (i.e. high potency sweeteners (or high intensity sweeteners)). Non-nutritive sweeteners including both natural and synthetic sweeteners (i.e. artificial sweeteners) and along with partially-nutritive sweeteners are an alternative to nutritive sweeteners to provide desirable taste characteristics as well as other functional properties with significantly lower caloric content. Non-nutritive sweeteners do not contribute to the caloric content of sweetener compositions.

Exemplary zero calorie sweeteners (i.e. non-nutritive, natural high-potency sweeteners) include sweeteners found in nature which may be in raw, extracted, purified, or any other form (e.g. via fermentation, bio-conversion), singularly or in combination thereof and characteristically have a sweetness potency greater than sucrose, fructose, or glucose, whiling having less calories. Non-limiting examples of natural zero calorie sweeteners include amino acids, tryptophans, steviolmonoside, steviolbioside, dulcoside A, dulcoside B, rubusoside, stevia, stevioside, mogroside, mogroside IV, mogroside V, mogroside VI, iso-mogroside V, grosmomoside, neomogroside, siamenoside, Luo Han Guo sweetener, monk fruit, siamenoside, monatin and its salts (monatin SS, RR, RS, SR), curculin, glycyrrhizic acid and its salts, thaumatin, monellin, mabinlin, brazzein, hemandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, and cyclocarioside I. Natural high-potency sweeteners also include modified natural high-potency sweeteners.

Exemplary amino acid additives include, but are not limited to, aspartic acid, arginine, glycine, glutamic acid, praline, threonine, theanine, cysteine, cystine, alanine, valine, tyrosine, leucine, arabinose, trans-4-hydroxyproline, isoleucine, asparagine, serine, lysine, histidine, omithine, methionine, carnitine, aminobutyric acid (α-, β-, and/or δ-isomers), glutamine, hydroxyproline, taurine, norvaline, sarcosine, and their salt forms such as sodium or potassium salts or acid salts. The amino acid additives also may be in the D- or L-configuration. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). As used herein, amino acids also encompass both peptides and polypeptides (e.g., di peptides, tripeptides, tetrapeptides, and pentapeptides) such as glutathione and L-alanyl-L-glutamine.

Exemplary polyamino acid additives include poly-L-aspartic acid, poly-L-lysine (e.g. poly-L-α-lysine or poly-L-ε-lysine), poly-L-omithine (e.g. poly-L-α-omithine or poly-L-ε-ornithine), poly-L-arginine, other polymeric forms of amino acids, and salt forms thereof (e.g. calcium, potassium, sodium, or magnesium salts such as L-glutamic acid mono sodium salt). Suitable sugar acid additives include, but are not limited to, aldonic, uronic, aldaric, alginic, gluconic, glucuronic, glucaric, galactaric, galacturonic, and salts thereof (e.g. sodium, potassium, calcium, magnesium salts or other physiologically acceptable salts), and combinations thereof. Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g. guanine, cytosine, adenine, thymine, uracil). Exemplary non-nutritive, synthetic high-potency sweeteners include those not found naturally in nature and characteristically having a sweetness potency greater than sucrose, fructose, or glucose, yet have fewer or no calories.

Further exemplary synthetic zero calorie (i.e. high-potency) sweeteners include sucralose, potassium acesulfame (Acesulfame-potassium), aspartame, alitame, saccharin, neohesperidin dihydrochalcone, cyclamate, neotame, advantame, N-[N-[3-(3-hydroxy-4-methoxyphenyl) propyl]-L-α-aspartyl]-L-phenylalanine I-methyl ester, N-[N-[3-(3-hydroxy-4-methoxyphenyl)-3-methylbutyl]-L-α-aspartyl]-L-phenylalanine I-methyl ester, N-[N-[3-(3-methoxy-4-hydroxyphenyl) propyl]-L-α-aspartyl]-L-phenylalanine I-methyl ester, salts thereof and the like. Synthetic high-potency sweeteners also include modified synthetic high-potency sweeteners.

Low calorie (i.e. partially-nutritive) sweeteners contribute to the calorie content of the composition. In some embodiments, the use of a low calorie sweetener may provide compositions that are “mid-calorie”, such that they impart the desired sweetness when added to a sweetenable composition (such as, for example, as beverage product) and have less than about 60 calories per 8 oz serving. In other embodiments, the use of a low calorie sweetener may provide compositions that are “low-calorie”, such that they impart the desired sweetness when added to a sweetenable composition (such as, for example, a beverage product) and have less than 40 calories per 8 oz serving.

Exemplary low calorie sweeteners include polylols. The term “polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group. Examples of polyols include, erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect the taste of the sweetened compositions.

Additional exemplary low calorie sweeteners include allulose (also referred to as D-allulose, psicose, D-psicose). In some embodiments, allulose includes mixtures of allulose and additional monosaccharides and disaccharides, determined according to the purity level of the allulose.

In some embodiments, fully caloric sweeteners can be included as nutritive sweeteners and often include carbohydrate sweeteners. Examples of carbohydrate sweeteners include, but are not limited to, sucrose, cane sugar, fructose, glucose, maple syrup, honey, molasses, erythritol, maltitol, lactitol, sorbitol, mannitol, xylitol, D-psicose, D-tagatose, leucrose, trehalose, galactose, rhamnose, cyclodextrin (e.g., a-cyclodextrin, P-cyclodextrin, and y-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrine, lactulose, melibiose, rhamnose, ribose, isomerized liquid sugars such as high fructose corn/starch syrup (HFCS/HFSS) (e.g., HFCS55, HFCS42, or HFCS90), coupling sugars, soybean oligosaccharides, glucose syrup and combinations thereof.

In another embodiment, the additional sweetener is selected from stevioside, mogroside, erythritol, allulose, HFCS, sucrose, cane sugar, aspartame, acesulfame-potassium, sucralose, and any combination of two or more of the foregoing.

Food, Beverage, and/or Consumable Products containing One or More Sweetener Composition Described Herein

One or more sweetener compositions described herein is suitable for use in diverse applications, including but not limited to food products, beverage products, and/or other consumable products. Among the advantages of the sweetener compositions is that they may be readily incorporated into known processes for making foods, beverages, and other consumable products without any additional processing steps. For example, the sweetener compositions described herein may be mixed with a solvent at room temperature or under heat (e.g. gradient heat treatment) before or when being combined with other ingredients of food, beverage, or other consumable products.

In any embodiment, a consumable food, beverage or other product comprises an effective amount of a steviol glycoside sweetener composition to provide a sucrose sweetness equivalence (SSE) of at least 1%. In any embodiment, a consumable food, beverage or other product comprises an effective amount of a steviol glycoside sweetener composition to provide a sucrose sweetness equivalence of at least 1%, at least 5%, at least 10%, at least 15%, or at least 20%. In any embodiment, the consumable is a food, beverage or other product having an equivalent sweetness to sucrose solutions having concentrations between 5 ppm and 10,000 ppm (1-40SSE).

In exemplary embodiments, the sweetener compositions can be included in beverage product compositions in amounts between about 5 ppm to about 5000 ppm, about 5 ppm to about 50 ppm, about 10 ppm to about 100 ppm, about 20 ppm to about 100 ppm; about 20 μm to about 200 ppm; about 20 ppm to about 300 ppm; about 20 ppm to about 400 pppm; about 20 ppm to about 500 ppm; about 50 ppm to about 500 ppm; about 100 ppm to about 500 ppm; about 100 ppm to about 700 ppm; about 100 ppm to about 800 ppm; about 100 ppm to about 900 ppm; about 100 ppm to about 1000 ppm; about 500 ppm to about 1000 ppm; about 500 ppm to about 1100 ppm; about 500 ppm to about 1200 ppm; about 500 ppm to about 1300 ppm; about 500 ppm to about 1400 ppm; about 500 ppm to about 1500 ppm; about 1000 ppm to about 1600 ppm; about 1000 ppm to about 1700 ppm; about 1500 ppm to about 1800 ppm; about 1500 ppm to about 1900 ppm; about 1500 ppm to about 2000 ppm, about 2000 ppm to about 2100 ppm; about 2100 ppm to about 2200 ppm; about 2200 ppm to about 2300 ppm; about 2300 ppm to about 2400 ppm; about 2400 ppm to about 2500 ppm; about 2500 ppm to about 2600 ppm; about 2600 ppm to about 2700 ppm; about 2700 ppm to about 2800 ppm; about 2800 ppm to about 2900 ppm, about 2900 ppm to about 3000 ppm, about 3000 ppm to about 3100 ppm, about 3100 ppm to about 3200 ppm, about 3200 ppm to about 3300 ppm, about 3300 ppm to about 3400 ppm, about 3400 ppm to about 3500 ppm, about 3500 ppm to about 3600 ppm, about 3600 ppm to about 3700 ppm, about 3700 ppm to about 3800 ppm, about 3800 ppm to about 3900, about 3900 to about 4000 ppm, about 4100 ppm to about 4200 ppm, about 4200 ppm to about 4300 ppm, about 4300 ppm to about 4400 ppm, about 4400 ppm to about 4500 ppm, about 4500 ppm to about 4600 ppm, about 4600 ppm to about 4700 ppm, about 4700 ppm to about 4800 ppm, about 4800 ppm to about 4900 ppm, about 4900 ppm to about 5000 ppm, or increments in between those recited.

In some embodiments, one or more beverage product described herein is a mid-calorie, low-calorie or zero-calorie, non-alcoholic and alcoholic beverage.

In exemplary embodiments, the sweetener compositions can be included in food product compositions in amounts between about 0.1 wt-% to about 50 wt-%, about 0.5 wt-% to about 40 wt-%, about 1 wt-% to about 40 wt-%, about 5 wt-% to about 35 wt-%, about 5 wt-% to about 30 wt-%, about 10 wt-% to about 30 wt-%, about 10 wt-% to about 25 wt-%, about 10 wt-% to about 20 wt-%, or increments in between those recited.

In other embodiments, the one or more throw syrup described herein comprises the steviol glycoside sweetener composition in a concentration of about 75 ppm to about 60,000 ppm, including all subranges and values that lie therebetween, based on the total composition of the throw syrup. In other embodiments, the one or more throw syrup described herein comprises the steviol glycoside sweetener composition in a concentration of about 450 ppm to about 15,000 ppm. In other embodiments, the one or more throw syrup described herein comprises the steviol glycoside sweetener composition in a concentration of about 750 ppm to about 25,000 ppm. In other embodiments, the one or more throw syrup described herein comprises the steviol glycoside sweetener composition in a concentration of about 18,000 ppm to about 60,000 ppm.

The disclosed concentrations of the steviol glycoside sweetener composition in the food, beverage, and/or other consumable products beneficially provides a desirable degree of a sugar-like characteristic to such food, beverage, and/or other consumable product composition, wherein the sugar-like characteristic can include maximal response, flavor profile, temporal profile, adaptation behavior, mouthfeel, concentration/response function behavior, tastant and flavor/sweet taste interactions, and temperature effects. In other embodiments, the sweetener compositions suppress, reduce or eliminate at least one undesirable taste associated with sweeteners, wherein the at least one undesirable taste can include delayed sweetness onset, lingering sweet aftertaste, metallic taste, bitter taste, cooling sensation taste, menthol-like taste, or licorice-like taste.

Exemplary food, beverage, and/or other consumable food product compositions containing a steviol glycoside sweetener composition are set forth in the following Table 1. The exemplary food, beverage, and/or other consumable food product compositions provide ppm ranges for the typical concentrations of the steviol glycoside sweetener composition when used as a single sweetener. Concentrations may vary depending upon formulation, flavor, and target consumer.

TABLE 1
Exemplary Consumable Products Containing the composition

| Applications | Range ppm (mg/l) | SSE (Final) |
|---|---|---|
| Juice and Juice beverages | 75-2000 | 1.5-12.0 |
| Carbonated soft drinks | 75-2500 | 1.5-15.0 |
| (CSDS) | | |
| Energy drinks | 75-2500 | 1.5-15.0 |
| Ready To Drink tea & | 75-2500 | 1.5-15.0 |
| coffee | | |
| Flavored water | 75-1500 | 1.5-10.0 |
| Dairy (including frozen | 75-3000 | 1.5-20.0 |
| dairy (e.g. ice cream) and | | |
| cheese) | | |
| Alternative Dairy | 75-3000 | 1.5-20 |
| Powdered beverages | 400-4000 | Varies |
| Tabletop | 600-15,000 | Varies |
| Cereal | 75-3000 | 1.5-20 |
| Confections (including | 75-3000 | 1.5-20 |
| jams and jellies) | | |
| Pharmaceuticals | 75-3000 | 1.5-20 |
| Chewing gum | 300-4000 | |
| Protein beverages | 75-2500 | 1.5-15.0 |
| Dressings | 75-1500 | 1.5-10.0 |
| Sauces/Gravy | 75-1500 | 1.5-10.0 |
| Desserts (including | 75-3000 | 1.5-20.0 |
| frozen) | | |
| Frozen foods | 75-4000 | |
| Fruit prep/concentrates | 75-12,000 | |
| Canned Food (including | 75-3000 | 1.5-20 |
| processed fruits & | | |
| vegetables) | | |
| Snacks | 75-2500 | 1.5-15 |
| Bars | 75-2500 | 1.5-15 |
| Dried blends | 75-4000 | |
| (coffee pods etc.) | | |
| Bakery products | 75-3000 | 1.5-20 |
| 5-1 Throw syrup for | 450-15,000 | 1.5-15.0 (single strength) |
| CSDS, Energy drinks | | |
| 9-1Throw syrup Coffee | 750-25,000 | 1.5-15.0 (single strength) |
| Water Enhancers (120 | 18,000-50,500 | 2.0-5.0 (single strength) |
| times) | | |

Examples of food products include, but are not limited to, confections, condiments, chewing gum, frozen foods, desserts, canned foods, soy-based products, dressings, mousse, bars, snacks, edible gel mixes and compositions, whipped topping, mayonnaise, sauces, gravy, spreads, vinegar, ice cream, cereal compositions, baked goods, dairy products such as yogurts, fruit preparations and concentrates, nondairy products, alternative dairy products, protein products, snacks, dried blends (e.g. coffee or beverage pods), and tabletop sweetener compositions.

Examples of beverage products include, but are not limited to, ready-to-drink products that are carbonated (e.g., colas or other soft drinks, sparkling beverages, alcoholic beverages and malts) or non-carbonated (e.g., fruit juices, fruit containing beverages, nectars, vegetable juices, sports drinks, energy drinks, enhanced water, coconut waters teas, RTD teas, non dairy beverages, protein beverages, meal replacement beverages, coffees, cocoa drinks, beverages containing milk, coffee creamers, beverages containing cereal extracts, smoothies, and alcoholic beverages), as well as powdered beverage products (dry mixes) that are to be combined with a liquid base such as water, milk, or club soda and beverage concentrates such as throw syrups. Throw syrups can be used to prepare any of the beverages described herein by adding an appropriate amount of water or other liquid medium.

In some embodiments, the beverage products and throw syrups disclosed herein may include a juice-based composition obtained from fruit or vegetable. The juice-based composition can be used in any form such as a juice form, a concentrate, an extract, a powder (which can be reconstituted with water or other suitable liquids), or the like. Suitable juices include, for example, non-citrus juices such as apple juice, grape juice, pear juice, nectarine juice, currant juice, raspberry juice, gooseberry juice, blackberry juice, blueberry juice, strawberry juice, custard-apple juice, pomegranate juice, guava juice, kiwi juice, mango juice, papaya juice, watermelon juice, cantaloupe juice, cherry juice, cranberry juice, peach juice, apricot juice, plum juice, and pineapple juice; citrus juices such as orange juice, lemon juice, lime juice, grapefruit juice, and tangerine juice; and vegetable juice such as carrot juice and tomato juice; or any combination thereof. The beverage products and throw syrups disclosed herein may comprise fruit or vegetable liquids containing a percentage of solids derived from the fruit or vegetable, for example pulp, seeds, skins, fibers, and the like, and pectin, which is naturally occurring in the fruit or vegetable. In some embodiments, the juice-based composition is fortified with solubilized calcium in the form of calcium carbonate, calcium lactate, calcium oxide, or calcium hydroxide.

In some embodiments, the beverage products and throw syrups disclosed herein comprise a dairy composition, wherein the dairy composition contains a dairy protein. Exemplary dairy compositions include any type of dairy product including cream, whole milk, reduced fat milk, skim milk, milk solids, condensed milk, or any combination thereof, specifically a combination of cream and skim milk. The dairy composition generally comprises an amount of dairy protein, for example whey protein containing beta-lactoglobulin, alpha-lactalbumin, or serum albumin; and the like. In some embodiments, the dairy product may be replaced with an amount of a non-dairy component such as soy milk, soy protein, almond milk, coconut milk, or any combination thereof.

The sweetener compositions described herein may also be used in dental compositions and pharmaceutical compositions.

Further description of exemplary food, beverage, and/or other consumable products suitable for including one or more sweetener compositions described herein is disclosed in International Publication No. WO2013096420, the portions of which that disclose exemplary food, beverage, and/or other consumable compositions that can be sweetened with one or more sweetener composition described herein are incorporated herein by reference in their entirety.

When incorporated into food, beverage, and/or other consumable products, the sweetener composition may be the sole sweetening components or other sugars and/or sweeteners may also be incorporated into the product.

The sweetener compositions may also be combined with one or more additives (that may or may not also be additional sweeteners) in the food, beverage, and/or other consumable products. Examples of additives include but are not limited to carbohydrates (also as described above in additional sweeteners), polyols (also as described above in additional sweeteners), amino acids and their corresponding salts (also as described above in additional sweeteners), sugar acids and their corresponding salts, nucleotides, organic acids, inorganic acids, organic salts, including organic acid salts and organic base salts, inorganic salts, bitter compounds, caffeine, flavorants and flavoring ingredients, astringent compounds, proteins or protein hydrolysates, surfactants, emulsifiers, weighing agents, juice, dairy, cereal and other plant extracts, gums, colorants, flavonoids, alcohols, polymers, essential oils, anti-fungal agents and combinations thereof.

The sweetener compositions may also be combined with one or more bulking agents (that may or may not also qualify as additives or additional sweeteners) in the food, beverage, and/or other consumable products. Bulking agents may, for example, be used to facilitate a direct substitution of the sweetener compositions disclosed herein for sugar in applications such as baking, cooking, and tabletop uses. Examples of bulking agents include but are not limited to: a bulk sweetener such as sucrose, dextrose, invert sugar maltose, dextrin, maltodextrin, fructose, levulose, and galactose; a low glycemic carbohydrate such as fructo-oligosaccharides, galacto-oligosaccharides, mannitol, inulin, xylitol, lactitol, erythritol, and maltitol; a fiber, such as polydextrose, resistant maltodextrin, resistant starch, soluble corn fiber, and cellulose; and a hydrocolloid, such as pectin, guar gum, carboxymethylcellulose, locust bean gum, gum arabic, xanthan gum and alginate. In some embodiments, the bulking agent is selected from maltodextrin, dextro-maltodextrin blends, corn syrup solids, sucrose, fructose, glucose, invert sugar, sorbitol, xylose, ribulose, mannose, mannitol, galactitol, lactitol, isomalt, maltose, tagatose, lactose, inulin, glycerol, polydextrose, fructooligosaccharides, cellulose and cellulose derivatives or combinations thereof.

In some embodiments, the consumable products (e.g. food, beverage, and/or other consumable products) do not include nutritive sweeteners including sucrose (i.e. table sugar), glucose, fructose, corn syrup (including high fructose corn syrup), maltose, lactose, molasses, honey, agave, fruit juice, maple syrup, and others. In other embodiments, the products contain a reduced amount of the nutritive sweeteners as they are beneficially replaced (or content reduced) by the addition of the sweetener compositions (or the sweetener compound of Formula (I)) disclosed herein. In exemplary embodiments the compositions include a reduction in nutritive sweeteners of at least about 80%, 75%, 70%, 65%, 60%, 55%, 50%, 45%, 40%, 35%, 30%, 25%, 20%, 15%, 10%, or 5% in the consumable products disclosed herein.

The sweetener compositions may also be combined with one or more functional ingredients in the food, beverage, and/or other consumable products. Examples of functional ingredients include but are not limited to saponins, antioxidants, dietary fiber sources, fatty acids, vitamins, glucosamine, minerals, preservatives, hydration agents, probiotics, prebiotics, long chain primary aliphatic saturated alcohols, phytosterols and combinations thereof.

In particular embodiments, the consumable product is a tabletop sweetener composition. In such embodiments, the sweetener compositions (or the sweetener compositions in combination with agents described in this embodiment) can further include at least one bulking agent, additive, anti-caking agent, functional ingredient and combinations thereof. The tabletop sweetener composition can be present in the form of a solid, suspension or a liquid; including co-crystallized sweetener compositions with a sugar or a polyol, agglomerated sweetener compositions, compacted sweetener compositions, dried sweetener compositions, particle sweetener compositions, spheronized sweetener compositions, spray dried compositions, granular sweetener compositions, liquid suspension compositions, and liquid sweetener compositions. Exemplary liquid tabletop sweetener can comprise water, and optionally additives, such, as for example polyols (e.g. erythritol, sorbitol, propylene glycol or glycerol), acidulants (e.g. citric acid, malic acid, tartaric acid, phosphoric acid), antimicrobial agents (e.g. benzoic acid or a salt thereof)

### Methods For Enhancing The Sugar-Like Characteristics Of A Consumable Food, Beverage, Or Other Product

In one embodiment, a method for imparting a sugar-like temporal profile, flavor profile, or both to a consumable food, beverage or other consumable product is provided. The method comprises providing a consumable food, beverage, or other product that is a sweetenable composition, and adding one or more sweetener composition described herein to such product to impart the desired degree of a sugar-like characteristic to such composition or product. The desirable characteristic can include maximal response, flavor profile, temporal profile, adaptation behavior, mouthfeel, concentration/response function behavior, tastant and flavor/sweet taste interactions, and temperature effects. In any embodiment, the method includes adding from about 5 ppm to about 5000 ppm of a steviol glycoside sweetener composition to the product, said composition comprising 5-30 wt % rebaudioside M (reb M), 15-35 wt % rebaudioside AM (reb AM), and 10-25 wt % rebaudioside N2 (reb N2) based on the total amount of steviol glycosides in the consumable product.

In another embodiment, a method for enhancing the sugar-like characteristics of a consumable food, beverage or other product is provided. In any embodiment, the method includes adding to a consumable product composition that is sweetenable a steviol glycoside sweetener composition comprising 5-30 wt % rebaudioside M (reb M), 15-35 wt % rebaudioside AM (reb AM), and 10-25 wt % rebaudioside N2 (reb N2) based on the total amount of steviol glycosides in the consumable product.

In an embodiment, reb M is present in an amount ranging from 10-25 wt % based on the total amount of steviol glycosides in the edible composition. In an embodiment, reb M is present in an amount ranging from 8-27 wt % based on the total amount of steviol glycosides in the edible composition. In an embodiment, reb AM is present in an amount ranging from 25-35 wt % based on the total amount of steviol glycosides in the edible composition. In an embodiment, reb N2 is present in an amount ranging from 10-20 wt % based on the total amount of steviol glycosides in the edible composition.

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Examples

Sweetness is commonly measured by comparison to reference solutions of sucrose. Sucrose is the standard to which all other sweeteners are compared. Taste panelists are often trained to quantitate sweetness on a 15 cm line scale, for convenience, using 2-15% sucrose solutions as references. (A common methodology employed in the industry).

Other sweeteners are then tasted at a series of dilutions to determine the concentration that is as sweet as a given percent sucrose reference. For example, if a 1% solution of sweetener X is as sweet as a 10% sucrose solution, then sweetener X is said to be 10 times as potent as sucrose. Since sweetness potency is strongly dependent on sucrose equivalency level for all high potency sweeteners (HPS), it is important to state the sucrose sweetness equivalency (SSE) level at which sweetness potency has been determined.

Sweetness potency of Composition A was examined relative to sucrose. Reference samples of 2.5%, 5.0%, 7.5% and 10.0% sucrose solutions were used. Composition A was added in acidified buffer water (pH 3.17) at ambient conditions. These samples were evaluated (n=3-6 tasters) in a blinded fashion using sip and spit methodology.

TABLE 2
Steviol glycoside composition (Composition A)

| Steviol | Range wt % of steviol glycoside |
|---|---|
| Glycoside | (by wt of total steviol glycosides) |
| Reb M | 11-24 |
| Reb AM | 28-32 |
| Reb O4 | 5-9 |
| Reb N2 | 13-16 |

As shown in Table 2, Composition A was found to be more potent (potency of 179 at 2.5% sucrose, 119 at 5%, 109 at 7.5% and 66 at 10% sucrose), had a higher sweetness intensity and very little licorice and bitter aftertaste. Composition A was able to reach 10% with a clean sweetness with no to low bitterness, no off-notes (metallic, licorice root, or earthy).

TABLE 3
Sweetness potency evaluations of Composition A

Sucrose Sweetness Equivalent (SSE)

| | 2.5% | 5% | 7.5% | 10% |
|---|---|---|---|---|
| Usage (ppm) | 140 | 420 | 690 | 1500 |
| Estimated potency | 179 | 119 | 109 | 66 |

The taste profile of Composition A was evaluated relative to known sweeteners (Reb AM and a high Reb A commercial product). These samples were evaluated (n=3-6 tasters) in a blinded fashion using comparative analysis approach and utilizing sip and spit methodology. The focus of the evaluation of sweetness profile, off-taste profile (described as bitter, sweet linger, sweetness onset, mouthfeel, mouth coating and metallic) and flavor profile. Qualitative descriptors for samples in water are provided in Table 4 by the tasters. A 5% sucrose solution in water was used as a control. Unlike other steviol glycosides including Reb A, there was no significant bitter or licorice off taste when evaluated in water.

TABLE 4
Comparison of sensory attributes of Composition
A versus other stevia sweeteners

| Composition (in buffered | |
|---|---|
| acidified water) | Sensory Attributes |
| 420 ppm Composition A | Composition A has cleaner finish compared |
| | to high Reb A and Reb AM |
| 423 ppm high Reb A | High Reb A has some sweet linger and some |
| commercial product | bitterness compared to Composition A |
| 330 ppm Reb AM | Reb AM has backend linger and slower onset |
| | compared to Composition A |

Taste profile of Composition A was also evaluated in pH 6.41 in different concentrations. Samples were tasted in a blinded fashion using comparative analysis approach and utilizing sip and spit methodology. The focus of the evaluation of sweetness profile, off taste profile (described as bitter, sweet linger, sweetness onset, mouthfeel, mouth coating and metallic) and flavor profile. Samples were prepared by solubilizing the desired concentration of the composition A in, neutral water pH 6.41 at ambient conditions. Samples were evaluated by 3-5 tasters. The samples were blind coded, randomized, and balanced. Qualitative descriptors for samples in water are provided in Table 5 by the tasters.

TABLE 5
Sensory attributes of Composition A.

| | |
|---|---|
| Composition A | |
| (in neutral | |
| water pH 6.41) | Sensory Attributes |

| 250 | ppm | Sweetness: Clean sweetness, (sweetness is |
|---|---|---|
| | | dominating basic taste). Very slightly delayed |
| | | onset, lower sweet lingering. |
| | | (Has a better finish at the end than Reb M). |
| | | Bitterness - no to low bitterness, no off-notes |
| | | (metallic, licorice root, or earthy). |
| 2,000 | ppm | Sweetness: Not medicinal, harsh or bitterness |

observed.
There is body/weight compared to straight
water.

Composition A displayed sucrose-like characteristics. The inclusion of the Composition A resulted in significant taste improvement across multiple attributes. Additionally, Composition A was able to reach 10% with a clean sweetness with no to low bitterness, no off-notes (metallic, licorice root, or earthy). Specific areas of taste improvement include bringing upfront sweetness, thickness, lowering sweet (linger) and bitter aftertaste, licorice, astringency, metallic and bitterness. Additionally, the results confirm that Composition A is a significantly cleaner tasting sweetener than Reb M, Reb AM and other commercial stevia products.

The taste profile of Composition A was evaluated relative to a known sweetener (High Reb M commercial product). Descriptive sensory analysis (Spectrum Descriptive Methodology) was performed by highly trained external panelists (14 panelists) using a 15-point universal scale with 3 replicates. The samples were balanced, randomized, and monadic with a time delay of 7 minutes between samples. Palate cleansers like spring water, unsalted crackers, and carbonated water were used. Panelists were trained to make sweetness ratings relative to sucrose standards.

Samples (Composition A) were prepared with spring water at 7 concentrations, (150 ppm, 475 ppm, 700 ppm, 1000 ppm, 1500 ppm and 2000 ppm) accounting for moisture. Samples were stored and evaluated at: ~40 °F.

Sucrose is the established gold standard—it provides the desired onset (appearance time) and decay of sweetness (extinction time). A key challenge in replacing sucrose with high potency sweeteners is to achieve a sweetness profile like sucrose. Zero-calorie, high potency sweeteners, can differ in temporal profile (delayed onset, lingering sweetness) contain detectable off tastes (metallic, licorice and bitter notes). There is a consumer desire for natural non-caloric sweetener that can have the same taste quality as sucrose (Gold standard for sweeteners). Indeed, it is well known in the food industry that HPS may have low maximal sweetness (e.g. AceK, Saccharin), which limits their utility in a wide range of sweetness equivalence in applications (Especially sweetness targets beyond a 8% sucrose). DuBois et al. (Concentration-Response Relationships of Sweeteners A Systematic Study, DOI: 10.1021/bk-1991-0450.ch020 (Dec. 31, 1991)) demonstrated in a dose-response study for numerous nutritive and non-nutritive sweeteners found that sweetness functions for HPS were hyperbolic, as perceived sweetness hit a ceiling and did not increase further as concentration increased. Conversely, monosaccharides, disaccharides, and sugar alcohols showed a linear dose-response (D-R) function.

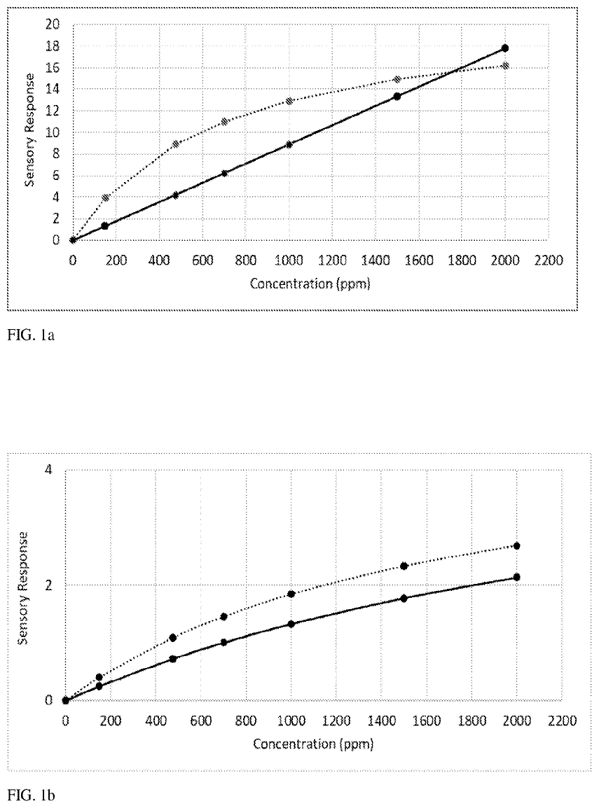

FIG. 1a demonstrates that Compound A unexpectedly exhibits a linear dose response for sweet taste across the tested range of concentrations; 0% to 0.2% (2000 ppm). Thus, we can infer that Composition A can deliver sweetness in a wide range of sweetness equivalents for various applications which can be highly beneficial to consumers.

Additionally, Composition A showed a lower bitter taste compared to Reb M (see FIG. 1b).

Data points 1500 ppm & 2000 ppm for commercial Reb M in FIGS. 1a and 1b were extrapolated. They were not evaluated.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

We claim:

1. A consumable food, beverage or other product comprising an effective amount of a steviol glycoside sweetener composition to provide a sucrose sweetness equivalence of at least 1%, said composition comprising 5-30 wt % rebaudioside M (reb M), 15-35 wt % rebaudioside AM (reb AM), and 10-25 wt % rebaudioside N2 (reb N2) based on the total amount of steviol glycosides in the consumable product.

2. The consumable product of claim 1, wherein the steviol glycoside sweetener composition further comprises rebaudioside 04 (reb 04).

3. The consumable product of claim 1, wherein the steviol glycoside sweetener composition is present in an amount from about 5 ppm to about 5000 ppm.

4. The consumable product of claim 1, wherein the steviol glycoside sweetener composition is present in an amount from about 75 ppm to about 60,000 ppm.

5. The consumable product of claim 1 further comprising at least one additive, bulking agent or functional ingredient, or a combination thereof.

6. The consumable product of claim 1, wherein the consumable product is a beverage product, beverage concentrate or a food product.

7. The consumable product of claim 1, wherein the consumable product is a dietary sweetener, dental product, and/or pharmaceutical product.

8. The consumable product of claim 1, wherein the consumable product is a food or beverage having an equivalent sweetness to sucrose solutions having concentrations between 5 ppm-10,000 ppm.

9. (canceled)

10. (canceled)

11. (canceled)

12. (canceled)

13. (canceled)

14. The consumable product of claim 1, wherein the product is a throw syrup configured for dilution with a liquid medium to form a beverage.

15. (canceled)

16. (canceled)
